(19) United States
(12) Patent Application Publication
(10) Pub. No.: US 2014/0019260 A1
(43) Pub. Date: Jan. 16, 2014

(54) SYSTEM AND METHOD FOR CREATING, DISTRIBUTING AND EXECUTING PROMOTIONAL MEDIA PLANS ACROSS USER DEVICE PLATFORMS

(71) Applicant: Kallol Borah, Bangalore (IN)

(72) Inventor: Kallol Borah, Bangalore (IN)

(73) Assignee: LUKUP MEDIA PRIVATE LIMITED PRIVATE LIMITED COMPMAY

(21) Appl. No.: 14/008,020

(22) PCT Filed: Mar. 30, 2012
(86) PCT No.: PCT/IN2012/000223

§ 371 Date: Sep. 27, 2013

(30) Foreign Application Priority Data
Mar. 31, 2011 (IN) 1082/CHE/2011

(51) Int. Cl. G06Q 30/02

(52) U.S. Cl. CPC G06Q 30/0276
USPC 705/14.69; 705/14.72

(57) ABSTRACT

The various embodiments herein disclose a system and method for creating, distributing and execution a promotional media plan across a plurality of user device platforms. The system comprising a publisher inventory module for providing a inventory of where promotions run, a promotion builder module to create a common media plan for multiple user device platforms, a campaign management server to enable multiple media agencies and multiple advertisers to create promotional media plans, a plurality of distribution channels for distribution of a promotional media plan to a plurality of user devices and a media package comprising of an application container packaged with the promotion media artifact and promotion media plan for delivering a plurality of promotions to the plurality of distribution channels and user devices. The promotional media plans are created subject to an availability of the advertising inventory.

### CROSS REFERENCE TO RELATED APPLICATION

The present application claims the priority of the Indian Provisional Patent Application with serial number 1082/CHE/2011 filed on 31 Mar., 2011 with the title “Cross-Platform Media Buying and Campaign Management Platform”, and the PCT application with serial number PCT/IN 2012/000223 filed on Mar. 30, 2012 with the title, “System and Method for Creating Distributing and Executing Promotional Media Plans across User Device Platforms” and the contents of both the applications are incorporated by entirety and by reference herein.

### BACKGROUND

1. Technical Field

The embodiments herein generally relate to execution of promotional campaigns and particularly relate to development, distribution and execution of a promotional media plan for a promotional campaign to run on multiple user devices. The embodiments herein more particularly relate to a system and method for distribution and execution of promotional media campaigns across multiple user device platforms based on a promotional media plan.

2. Description of the Related Art

Advertisers provide a media agency with a product they wish to advertise along with a customer segment to be targeted for the particular product. Depending on the targeted customer segment, the media agency creates a promotional media plan which typically involves launching multiple promotional campaigns across multiple distribution channels such as internet, television, mobile, radio, print etc.

After creation of the promotional media plan, a media buyer buys the media from relevant distribution channels in accordance with the target audience, budget etc. The media buyer books multiple slots on various mediums as per the promotional media. Media owners engage sales teams to drive sales of their advertising inventory. After the slots have been bought and reserved, a creative team creates banners, videos, audios and other promotional artifacts pertaining to the promotional media plan. After the promotional artifact is ready, the scheduling of delivery of the advertisement campaigns is carried out by campaign managers. The campaign managers then send the promotional artifact for the promotional campaign to the selected distribution channels.

Campaign management functions for internet based promotional campaigns are now managed by a multitude of web based applications. However, there is no platform for allowing media buyers to plan, deliver and execute promotional media plans to multiple user devices such as televisions, mobile phones and hybrid media devices running on different platforms (different OS, middleware and hardware). Hence, advertisers and media agencies are unable to effectively manage and track parallel campaigns run across user device platforms to achieve promotional campaign objectives.

Hence there is a need to provide a system and method for development, distribution and execution of a platform independent media plan for multiple user devices. There is also a need for a system and method for managing advertising inventory on various media platforms and managing promotional campaigns based on availability of inventory. Moreover, there is a need for a platform for development and distribution of a content and application representing a promotional campaign which can be rendered on any user device irrespective of the user device platform.

The above mentioned shortcomings, disadvantages and problems are addressed herein and which will be understood by reading and studying the following specification.

### SUMMARY

The primary object of the embodiments herein is to provide a system for creating, distributing and executing a promotional media plan representative of a promotional campaign across a plurality of user device platforms.

Another object of the embodiments herein is to provide a system and method for managing advertising inventory across media platforms and managing promotional campaigns based on availability of inventory, performance and target audience.

Another object of the embodiments herein is to provide a system and method to create a platform independent media plan for a plurality of user device platforms.

Yet another object of the embodiments herein is to provide an appropriate way to render a promotional campaign on a plurality of user device platforms based on the execution of a promotional media plan.

Yet another object of the embodiments herein is to provide a system and method which allow a marketer of a product to collect and process campaign performance data in such a way as to maximize the value of a promotion to both the marketer of the product and a consumer of the product.

These and other objects and advantages of the embodiments herein will become readily apparent from the following detailed description taken in conjunction with the accompanying drawings.

The various embodiments of the herein provide a system for creating and distributing a promotional media plan across a plurality of user device platforms. The system comprising a publisher inventory module for providing a inventory of where promotions run, a promotion builder module to create a common media plan for multiple user device platforms, a campaign management server to enable multiple media agencies and multiple advertisers to create promotional media plans, a plurality of distribution channels for distribution of a promotional media plan to a plurality of user devices, a communication network to facilitate the campaign management server to communicate with the plurality of distribution channels and a media package comprising of an application container packaged with the promotion media artifact and promotion media plan for delivering a plurality of promotions to the plurality of distribution channels and user devices. The promotional media plans are created subject to an availability of the advertising inventory.

According to an embodiment herein, the promotion media artifact includes a static content, a plurality of platform specific data formats corresponding to the promotional media plan and a content associated with the promotional media campaign.

According to an embodiment herein, the promotional media plan is devised for a promotional media artifact comprising at least one of an image, wallpaper, an audio clip, a caller tune, a video clip, an interactive software application, a game, a contest, an advertisement or a content promotion.

According to an embodiment herein, the plurality of distribution channels include at least one of a mobile network, a mobile operator application store, a mobile push notification channel, a handset application store, a connected television, an internet portal, a broadcast television channel, a social network and a hybrid media device.

According to an embodiment herein, the media plan is delivered to the plurality of user device platforms based on a pre-defined schedule or based on a request from a user device, wherein the common media plan includes a promotion metadata compatible with multiple user device platforms.

According to an embodiment herein, the user device is at least one of a television, a mobile communication device or a hybrid media device.

According to an embodiment herein, the plurality of user device platforms comprises a plurality of television platforms with each of the television platform having a different middleware, operating systems and hardware components, a plurality of mobile communication device platforms with each of the mobile communication device platform having a different mobile operating system and middleware and a plurality of hybrid media device platforms with each of the hybrid media device platform having a different operating system, middleware and hardware components.

According to an embodiment herein, the publisher inventory specified by the publisher inventory module is an available supply of traffic or impressions that a publisher sells to multiple advertisers interested in targeting an audience group, where the publisher inventory includes at least one of a plurality of channel distribution policies, a distribution frequency, a location to deliver the promotion, a type of user's device, size of the display, duration of the display and position of the display on at least one of a TV, mobile communication device and hybrid device.

According to an embodiment herein, the promotion builder module comprises an audience targeting module to enable promotion of the promotional media artifact to a targeted audience based on at least one of demographics, language, location and viewing history and a scheduler module for scheduling a delivery of a promotional media plan to a plurality of user devices.

According to an embodiment herein, the system further comprises a provisioning module to deliver the promotion media plan to the plurality of user device platforms through the plurality of distribution channels, a billing module to process an amount payable for the performance of the promotional media plan and a performance tracking module to track and generate a representation of a comparison of performance of the promotion media plan on each of the plurality of user device.

According to an embodiment herein, the performance tracking module is further adapted for tracking and comparing the performance of multiple publishers, the plurality of distribution channels, the plurality of user device platforms, a plurality of service providers and the promotional media plans, tracking a performance of the promotion media artifact on multiple user device platforms for the plurality of service providers and organizing and displaying a performance data for the promotional media plan according to a client's requirement.

According to an embodiment herein, the system further comprising a distribution module is adapted for packaging the promotional media artifact and associated content specific to a user device platform, packaging the promotion metadata based on a common promotional media plan; and packaging a application container into a media package. The promotion metadata includes at least one of a media plan and a information related to availability of inventory and scheduling the display of the promotion media artifact specific to the user device platform.

According to an embodiment herein, the promotion metadata for the television includes a service identification number, a service name, a service type, a display time, a display date, a location of the device, a type of television display, a type of television display format and a frequency of the display.

According to an embodiment herein, the promotion metadata for the mobile communication device includes user device information, device software, a display date, a display time, a frequency of display and a location of the device.

According to an embodiment herein, the promotion metadata for the hybrid media device includes a service identification number, a service name, a service type, a display time range, a display date, a location of the hybrid media device, a display format and a user's profile information.

The embodiments herein further provide a method for creating, distributing and executing a promotional media plan across a plurality of user device platforms. The method comprises specifying publishing inventory for a plurality of media platforms, creating promotional campaigns and media plans thereof subject to availability of publishing inventory, scheduling a delivery of the promotional media plan for each of the promotional campaign, generating a plurality of platform specific data formats representing the media plan for the plurality of promotional campaigns, packaging the promotional media plan with an application container corresponding to a user device platform, the plurality of platform specific data formats, and the content into a platform specific media package, distributing a plurality of device specific media packages to the plurality of user device platforms through a plurality of distribution channels, delivering the plurality of device specific media packages to a user device based on at least one of demographics, language, location and viewing history and processing the plurality of device specific media packages on the user device platform before rendering the promotional media campaign.

According to an embodiment herein, the promotion media artifact associated with a promotional campaign is any of an image, wallpaper, an audio clip, a caller tune, a video clip, an interactive software application, a game, a contest, an advertisement or a content promotion.

According to an embodiment herein, the promotion media artifact is any of an image, wallpaper, an audio clip, a caller tune, a video clip, an interactive software application, a game, a contest, an advertisement or a content promotion.

According to an embodiment herein, processing the plurality of device specific media packages on the user device platform comprising steps of requesting media plan details which includes at least one of a plurality of channel distribution policies, a display frequency, a user's location, a type of user's device, size of the display, duration of the display and position of the display on at least one of a TV, mobile communication device and hybrid device, executing the promotional media plan by comparing meta data such as location, service, time and date ranges for the promotion with the actual state of the user device and rendering the content contained in the promotional media artifact associated with a promotional campaign on the user device.

According to an embodiment herein, delivering the device specific media packages to the plurality of distribution channels includes at least one of a push activity in case of a television and a pull activity in case of the mobile communication device and hybrid media device.

According to an embodiment herein, delivering the device specific media packages to a television platform comprises encoding the media package, streaming the media package using a broadcasting system, acquire the media package on a set top box an decoding the media package on the set top box. Here the media package for television is specific to the broadcasting system platform and the set top box platform.

According to an embodiment herein, delivering the device specific media packages to the mobile communication device comprises packaging the promotional metadata, the static content and the application container and push or pull the media package on to the mobile communication device.

According to an embodiment herein, delivering the device specific data packages to the hybrid media device comprises packaging the promotional metadata, the static content and the application container and push or pull the media package on to the hybrid media device.

According to an embodiment herein, the method further comprises provisioning a usage of the promotional media artifact on the plurality of user devices based on the promotional media plan, receiving a reporting information from the plurality of user devices, tracking and collecting a performance data from the plurality of user device platforms, obtaining a billing data based on the performance, organizing and displaying a billing and payment options according to the client's requirements and organizing and displaying the performance data according to the client's requirements.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF THE DRAWINGS

The other objects, features and advantages will occur to those skilled in the art from the following description of the preferred embodiment and the accompanying drawings in which:

The embodiments herein will be better understood from the following detailed description with reference to the drawings, in which:

FIG. 1 is a block diagram illustrating a system for creating and distributing a promotional media plan across a plurality of user device platforms, according to an embodiment of the present disclosure.

FIG. 2 illustrates a schematic view of a user interface of a promotion builder module, according to an embodiment of the present disclosure.

FIG. 3 illustrates a schematic view of a promotional campaign creation form for television, according to an embodiment of the present disclosure.

FIG. 4 illustrates a schematic view of a promotional campaign scheduler form for television, according to an embodiment of the present disclosure.

FIG. 5 is a schematic diagram illustrating a user interface of a performance tracking module, according to an embodiment of the present disclosure.

FIG. 6 is a schematic diagram illustrating a user interface of a billing module, according to an embodiment of the present disclosure.

FIG. 7 is an exemplary illustration of execution of a promotion media campaign on a television platform, according to an embodiment of the present disclosure.

FIG. 8 is an exemplary illustration of execution of a promotion media campaign on a mobile device platform, according to an embodiment of the present disclosure.

FIG. 9 is an exemplary illustration of execution of an online campaign, according to an embodiment of the present disclosure.

FIG. 10 is an exemplary illustration of execution of a promotion media campaign on a hybrid media device platform, according to an embodiment of the present disclosure.

FIG. 11 is an exploded view illustrating a typical set top box layer model, according to an embodiment of the present disclosure.

FIG. 12 illustrates a media package for a television, according to an embodiment of the present disclosure.

FIG. 13 illustrates a media package for a mobile communication device, according to an embodiment of the present disclosure.

FIG. 14 is a schematic diagram illustrating a computer architecture used in accordance with the embodiment of the present disclosure.

FIG. 15 is a flowchart illustrating a method for creating, distributing and executing a promotional media plan across a plurality of user device platforms, according to an embodiment of the present disclosure.

These and other aspects of the embodiments of the present disclosure will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### DETAILED DESCRIPTION OF THE DRAWINGS

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

The various embodiments of the present disclosure provide a system for creating and distributing a promotional media plan across a plurality of user device platforms. The system comprising a publisher inventory module for providing a inventory of where promotions run, a promotion builder module to create a common media plan for multiple user device platforms, a campaign management server to enable multiple media agencies and multiple advertisers to create promotional media plans, a plurality of distribution channels for distribution of a promotional media plan to a plurality of user devices, a communication network to facilitate the campaign management server to communicate with the plurality of distribution channels and a media package comprising of an application container packaged with a promotion media artifact and the promotional media plan for delivering a plurality of promotions to the plurality of distribution channels and user devices. The promotional media plans are created subject to an availability of the publishing inventory.

The promotion media artifact includes a static content, a plurality of platform specific data formats corresponding to the promotional media plan and content associated with the promotional media campaign.

The promotional media plan is devised for a promotion media artifact comprising at least one of an image, wallpaper, an audio clip, a caller tune, a video clip, an interactive software application, a game, a contest, an advertisement or a content promotion.

The plurality of distribution channels include at least one of a mobile network, a mobile operator application store, a mobile push notification channel, a handset application store, a connected television, an internet portal, a broadcast television channel, a social network and a hybrid media device.

The media plan is delivered to the plurality of user device platforms based on a pre-defined schedule or based on a request from a user device, wherein the media plan includes a promotion metadata compatible with multiple user device platforms.

The user device is at least one of a television, a mobile communication device or a hybrid media device.

The plurality of user device platforms comprises a plurality of television platforms with each of the television platform having a different middleware, operating systems and hardware components, a plurality of mobile communication device platforms with each of the mobile communication device platform having a different mobile operating system and middleware and a plurality of hybrid media device platforms with each of the hybrid media device platform having a different operating system, middleware and hardware components.

The publisher inventory specified by the publisher inventory module is an available supply of traffic or impressions that a publisher sells to multiple advertisers interested in targeting an audience group, where the publisher inventory includes at least one of a plurality of channel distribution policies, a distribution frequency, a location to deliver the promotion, a type of user's device, size of the display, duration of the display and position of the display on at least one of a TV, mobile communication device and hybrid device.

The promotion builder module comprises an audience targeting module to enable promotion of the promotional media artifact to a targeted audience based on at least one of demographics, language, location and viewing history and a scheduler module for scheduling a delivery of a promotional media plan to a plurality of user devices.

The system further comprises a provisioning module to deliver the promotional media plan to the plurality of user device platforms through the plurality of distribution channels, a billing module to process an amount payable for the performance of the promotional media plan and a performance tracking module to track and generate a representation of a comparison of performance of the promotion media plan on each of the plurality of user device.

The performance tracking module is further adapted for tracking and comparing the performance of multiple publishers, the plurality of distribution channels, the plurality of user device platforms, a plurality of service providers, the promotional media plans, tracking a performance of the promotion media artifact on multiple user device platforms for the plurality of service providers and organizing and displaying a performance data for the promotional media plan according to a client's requirement.

The system further comprising a distribution module adapted for packaging the promotional media artifact and associated content specific to a user device platform, packaging the promotion metadata based on a common promotional media plan and packaging an application container into a media package. The promotion metadata includes at least one of a media plan and an information related to availability of inventory and scheduling the display of the promotion media artifact specific to the user device platform.

The promotion metadata for the television includes a service identification number, a service name, a service type, a display time, a display date, a location of the device, a type of television display, a type of television display format and a frequency of the display.

The promotion metadata for the mobile communication device includes a user device information, device software, a display date, a display time, a frequency of display and a location of the device. The promotion metadata for the hybrid media device includes a service identification number, a service name, a service type, a display time range, a display date, a location of the hybrid media device, a display format and a user's profile information.

Embodiments herein further provide a method for creating, distributing and executing a promotional media plan across a plurality of user device platforms. The method comprises specifying publishing inventory for a plurality of media platforms, creating promotional campaigns and media plans thereof subject to availability of the publishing inventory, scheduling a delivery of the promotional media plan for each of the promotional campaign, generating a plurality of platform specific data formats representing the media plan for the plurality of promotional campaigns, packaging the promotional media plan with an application container corresponding to a user device platform, the plurality of platform specific data formats and the content into a platform specific media package, distributing a plurality of device specific media packages to the plurality of user device platforms through a plurality of distribution channels, delivering the plurality of device specific media packages to a user device based on at least one of demographics, language, location and viewing history and processing the plurality of device specific media packages on the user device platform before rendering the promotional media campaign.

The promotion media artifact associated with a promotional campaign is any of an image, wallpaper, an audio clip, a caller tune, a video clip, an interactive software application, a game, a contest, an advertisement or a content promotion.

The promotion media artifact is any of an image, wallpaper, an audio clip, a caller tune, a video clip, an interactive software application, a game, a contest, an advertisement or a content promotion.

Here processing the plurality of device specific media packages on the user device platform comprising steps of requesting media plan details which includes at least one of a plurality of channel distribution policies, a display frequency, a user's location, a type of user's device, size of the display, duration of the display and position of the display on at least one of a TV, mobile communication device and hybrid device, executing the promotional media plan by comparing metadata such as location, service, time and date ranges for the promotion with the actual state of the user device and rendering the content contained in the promotional media artifact associated with a promotional campaign on the user device.

The method of delivering the device specific media packages to the plurality of distribution channels includes at least one of a push activity in case of a television and a pull activity in case of a mobile communication device and a hybrid media device. The method of delivering the device specific media packages to a television platform comprises encoding the media package, streaming the media package using a broadcasting system, acquire the media package on a set top box an decoding the media package on the set top box. Here the media package for television is specific to the broadcasting system platform and the set top box platform and delivering the device specific media packages to the mobile communication device comprises packaging the promotional metadata, the static content and the application container and push or pull the media package on to the mobile communication device.

The process of delivering the device specific data packages to the hybrid media device comprises packaging the promotional metadata, the static content and the application container and push or pull the media package on to the hybrid media device.

The method further comprises provisioning a usage of the promotional media artifact on the plurality of user devices based on the promotional media plan, receiving a reporting information from the plurality of user devices, tracking and collecting a performance data from the plurality of user device platforms, obtaining a billing data based on the performance, organizing and displaying a billing and payment options according to the client's requirements and organizing and displaying the performance data according to the client's requirements.

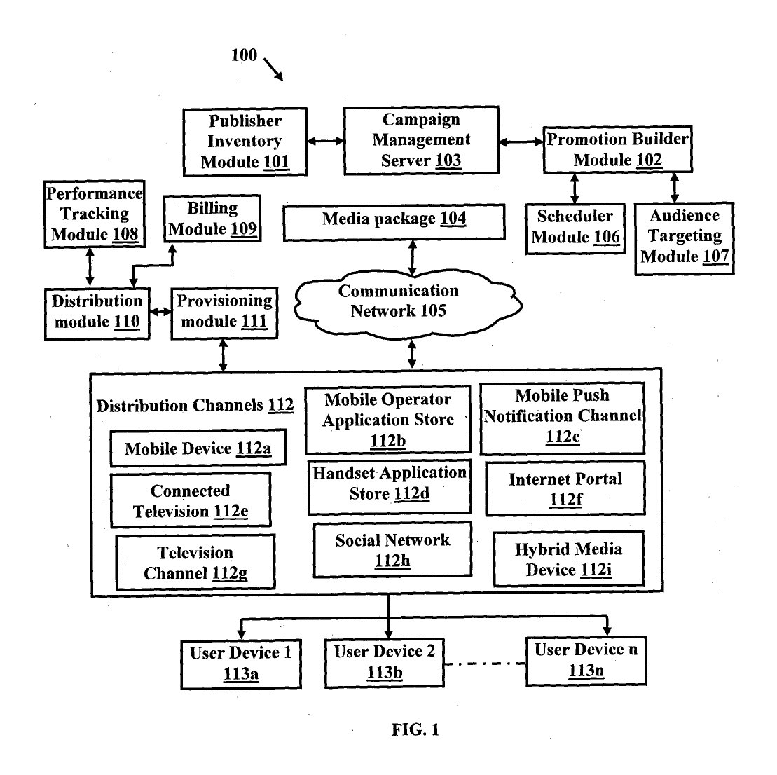

FIG. 1 is a block diagram illustrating a system for creating and distributing a promotional media plan across a plurality of user device platforms, according to an embodiment of the present disclosure. The system 100 comprises a publisher inventory module 101, a promotion builder module 102, a campaign management server 103, a media package 104, a scheduler module 106, an audience targeting module 107, a distribution module 110, a provisioning module 111, a performance tracking module 108, a billing module 109, a plurality of distribution channels 112, and a communication network 105 to facilitate the campaign management server 103 to communicate with the plurality of distribution channels 111.

The publisher inventory module 101 allow a media publisher such as television channels and online websites to specify publishing inventory available for advertising, the promotion builder module 102 enables an agency to manage multiple advertiser accounts or an advertiser to maintain multiple brands, a campaign management server 103 enables multiple media agencies and multiple advertisers to create the promotional media plan and the plurality of distribution channels 112 enables distribution of the promotional media plan to a plurality of user devices 113a-113n. The distribution channels includes, but not limited to a mobile device 112a, a mobile operator application store 112b, a mobile push notification channel 112c, a handset application store 112d, a connected television 112e, an internet portal 1122E a television channel 112g, a social network 112h and a hybrid media device 106i.

The promotion builder module 102 introduces advertising material and brand information to the campaign management server 103. The campaign management server 103 communicates with the plurality of distribution channels 104 via the communication network 105.

The system 100 further contains a media package 104 having a promotion media plan for delivering a plurality of interactive promotions to the plurality of distribution channels 112. The media package 104 is specific to a user device. The media package 104 includes an application container, a plurality of platform specific data formats corresponding to a promotional media plan and content associated with the promotional media campaign.

The user device 113a-113n is at least one of a television, a mobile communication device and a hybrid media device. The plurality of user device platforms comprises a plurality of television platforms with each television platform implementing a different middleware, operating technology and hardware components, a plurality of mobile communication device platforms with each mobile communication device platform having a different mobile operating system and a plurality of hybrid media device platforms with each hybrid media device platform having different operating systems, middleware and hardware components.

The promotional media plan is devised for a promotional media artefact. The promotional media artetfact comprises at least one of an image, wallpaper, an audio clip, a caller tune, a video clip, an interactive software application, a game, a contest, an advertisement or a content promotion.

The campaign management server 103 enables the promotion builder module 102 to create the promotional media plan subject to availability of publishing inventory as specified by the publisher inventory module 101 and to schedule the delivery of the promotional media plan. The media plan is delivered to the plurality of user device platforms based on a pre-defined schedule or based on a request from a user device. The application container renders the content and the plurality of user interface elements onto the user device 113 based on the successful execution of the media plan.

The system further comprises a distribution module 110, a provisioning module 111 to deliver the promotional media plan to the plurality of user device platforms through the plurality of distribution channels 112, a billing module 109 to process an amount payable for the performance of the promotional media plan, a performance tracking module 108 to track and generate a representation of a comparison of performance of the promotion media plan on each of the plurality of user devices 113a-113n.

Here, the publisher inventory specified by the publisher inventory module 101 is an available supply of traffic or impressions that the publisher sells to the multiple advertisers interested in targeting the audience. The publisher inventory includes at least one of a plurality of channel distribution policies, a distribution frequency, a location to deliver the promotion, a type of user's device, size of the display, duration of the display and position of the display on at least one of a TV, mobile communication device and hybrid device.

The promotion builder module 102 includes an audience targeting module 107 and a scheduler module 106. The promotion builder module 102 populates a TV promotion metadata that describes a TV media plan, the mobile promotion metadata that describes a mobile media plan, and the internet promotion metadata that describes an online media plan.

The distribution module 110 is adapted to distribute the promotional media plan to the multiple user device platforms according to a promotion delivery schedule. The distribution module 110 packages a content specific to a TV platform, a TV promotion metadata based on the common media plan and an application container together into a TV media package. The TV promotion metadata is specific to the TV platform. The distribution module 203 further encodes and streams the TV media package to a TV device. The content specific to the TV platform and is delivered and rendered on the TV device based on the TV promotion metadata.

Similarly, the distribution module 110 packages a content specific to a mobile platform, a mobile promotion metadata based on the common media plan and the application container together into a mobile media package 104 for the mobile platform. The mobile promotion metadata is specific to the mobile platform. The distribution module 110 further distributes the mobile media package to a mobile device. The content specific to the mobile platform is delivered and rendered on the mobile device based on the mobile promotion metadata.

Similarly, the distribution module 110 packages a content specific to a hybrid media device platform, a hybrid media device promotion metadata based on the common media plan and the application container together into a media package for the hybrid media device platform. The hybrid device media promotion metadata is specific to the hybrid media device platform. The distribution module 110 further distributes the hybrid device media package to a hybrid media device.

The promotion metadata for the television includes a service identification number, a service name, a service type, a display time, a display date, a location of the device, a type of television display, a type of television display format, a frequency of the display. The promotion metadata for the mobile communication device includes a user device information, device software, a display date, a display time, a frequency of display and a location of the device. The promotion metadata for the hybrid media device includes a service identification number, a service name, a service type, a display time range, a display date, a location of the hybrid media device, a display format and a user's profile information.

The media package 104 is delivered or distributed to the user devices based on the device type. For a television, the promotion media plan, application container and the content are packaged, encoded, and streamed on a broadcasting system. The streamed data is then decoded at the television or set top box. The media plan for television is operating system platform specific. Similarly, for mobile communication device, promotion media plan, application container and the content are packaged and delivered either by push or on request by the mobile device. Similarly for the hybrid media device, a promotion media plan, application container and the content are packaged and delivered on request to the hybrid media device. For an online or internet page, the promotional metadata is packaged with the promotional content accessible by a Uniform Static content Locator (URL).

The promotion builder module 102 enables the creation of a promotional media campaign and associates a promotional media artefact to it. The scheduler module 106 enables scheduling a publication of the promotion media artefact. In one embodiment, in which the distribution channel 112 selected is the television channel 112g, the scheduler module 106 provides a list of television channels, corresponding programme timings and slots available for displaying the promotional campaign. The scheduler module 209 may provide time slots available for pushing a promotional campaign to other platforms such as mobile communication devices, hybrid media device etc. In one embodiment, the promotional campaign can pulled from the distribution channels. The audience targeting module 107 enables promotion of the promotion media artefact to a targeted audience based on demographics, language, location (e.g. PIN code, rural, urban, etc.), viewing history etc.

The application container in the device specific media package 104 renders the promotion media artefact on the corresponding user device based on the availability of publishing inventory and conditions mentioned in the promotional meta data contained in the media package 104c distributed on that user device.

The distribution channel communication module obtains information from the plurality of distribution channels 112 on a plurality of promotional media artifacts sent to the plurality of user devices. The information includes performance parameters on each distribution channel and each platform. The distribution channel communication module communicates raw billing and performance data from the plurality of platforms such as television, mobile communication device, hybrid media device platforms and the like to the performance and billing data communication module.

The performance and billing data communication module stores and communicates the raw billing data to the billing module 109 which organises and displays bills and payment options as per the client requirements and usage. The raw performance data is communicated to the performance tracking module 108 by the billing and performance data communication module. The performance tracking module 108 organises and displays the performance data as per the client requirements to track and compare performance of multiple publishers, distribution channels, platforms, service providers, operators etc. The performance tracking module 108 processes the reporting information to track a performance of the TV promotion, the mobile promotion, the hybrid media promotion, and the internet promotion on the different communication network operators and the plurality of devices. The performance tracking module 108 tracks a performance of the promotion media artefact on a plurality of platforms for a plurality of service providers.

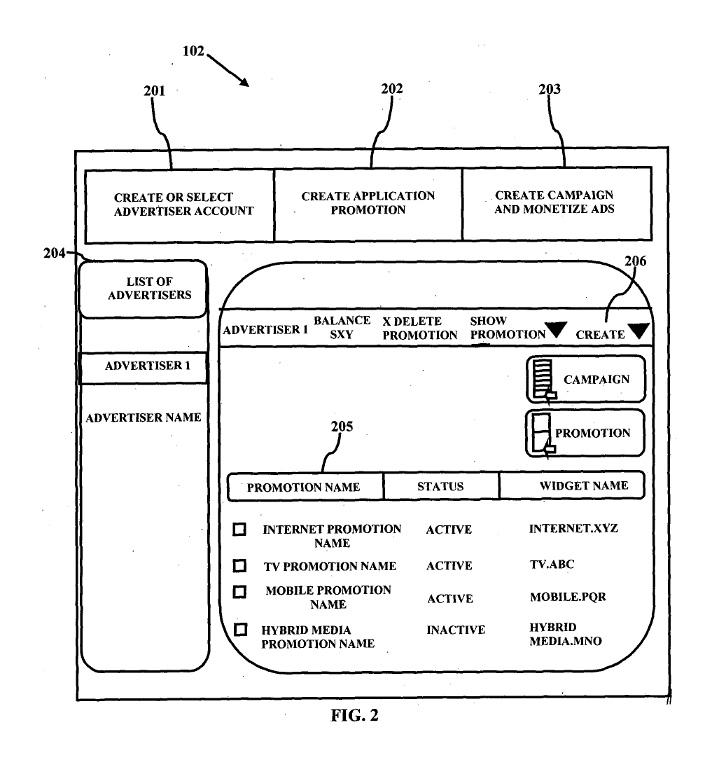

FIG. 2 illustrates a schematic view of a user interface of a promotion builder module, according to an embodiment of the present disclosure. According to FIG. 2, the user interface of the promotion builder module 102 includes a tool 201 to select or create an advertiser account, a tool 202 to create a promotion, a tab 203 to create campaign and monetize ads, a list of advertisers 204, a promotion type and status tool bar 205 and a create button. The tool 201 to create or select an advertiser 201 enables the agency or advertiser to create a new advertiser account or to select from an existing set of advertiser accounts. The tool 202 to create promotional campaigns 202 allows for creating a plurality of promotions.

The list of advertisers 204 maintains one or more details of the advertisers. On entering a particular advertiser's name in the list of advertisers 204, a table is displayed for displaying the promotion type and status tool bar 205. The promotion type and status tool bar 405 displays a status of the promotion and the name of the interactive application associated with that promotion. The type and status tool bar 205 also displays balance of payments. The create button 206 enables the user to create promotional campaigns.

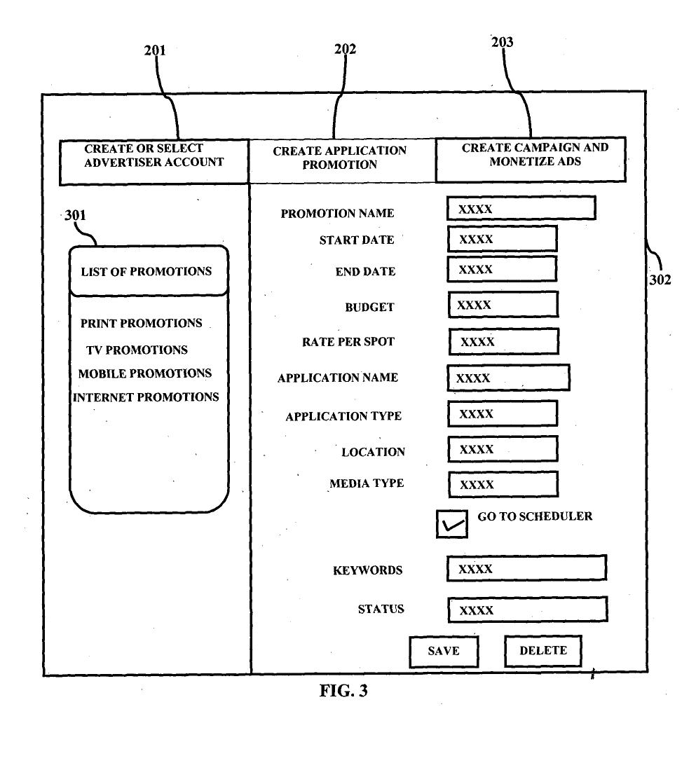

FIG. 3 illustrates a schematic view of a promotional campaign creation form for television, according to an embodiment of the present disclosure. The form allows creating promotions on a television platform. The list of promotions 302 maintains a list of available promotions such as but not limited to a news promotion, a web promotion or an internet protocol television promotion or a mobile promotion. The promotion campaign creation form creates a promotion by allowing the entry of information regarding a promotion. The promotion campaign creation form also displays a rate payable for delivery of a promotion. In case of the promotional campaign rendered to television channels, the rate for delivery may be a rate per spot for an advertisement.

In one embodiment, the create campaign and monetize ads tab 203 display a promotion name, a start date of the promotion, an end date of the promotion, a budget of the promotion, rates of the promotion, a name of the promotional campaign to be promoted, a type of the promotional campaign, a target location for the promotion to run, a media type for the promotion, a name of distributor, one or more keywords for the promotion and a status information for the promotion.

In one embodiment, the scheduler module is used to schedule the display of promotions. For example, the user may select a schedule preference for a promotion campaign to appear between 8 PM-11 PM on Mondays for the television platform for a particular targeted audience.

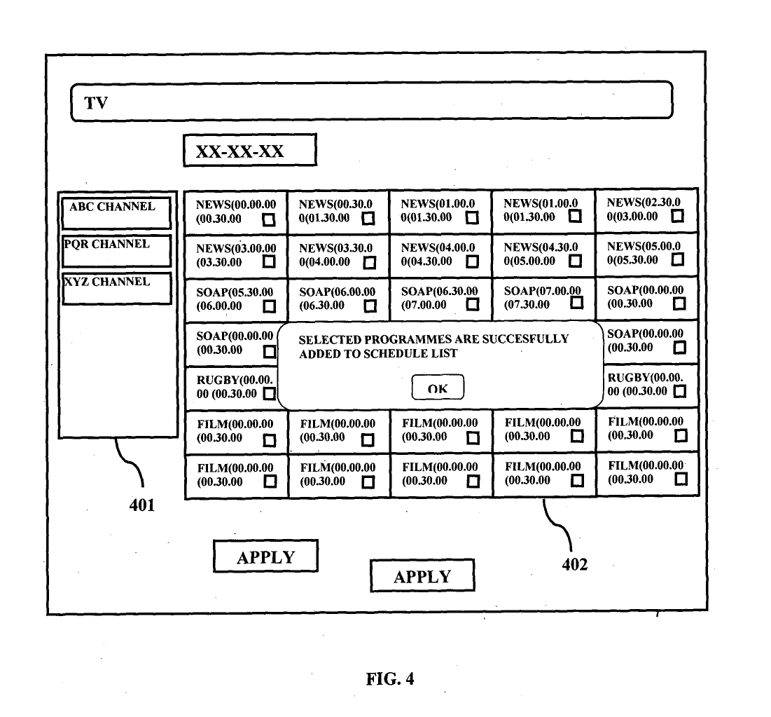

FIG. 4 illustrates a schematic view of a promotional campaign scheduler form for television, according to an embodiment of the present disclosure. The promotional campaign scheduler form includes a list of distribution channels and a schedule of events 402 on a selected distribution channel. The distribution channel can be a television channel, a mobile device or a social network. The schedule of events 402 displays the timings of various spots available for pushing the promotional campaigns. The promotion builder selects a particular distribution channel where they wish to promote the promotion media artifact by selecting from the list of distribution channels. In one embodiment, on selection of a TV scheduler, a list of available TV channels 401 is displayed. After selection of a television channel (ABC channel), the schedule of events 402 for the selected channel is displayed. The programmes on the list are then selected to run/display the promotion media artifact when the programme is aired at its stipulated time.

The slots of the schedule of events 402, in case of other platforms and/or distribution channels such as mobile devices and social networks can be based on upcoming offers, local shows and events.

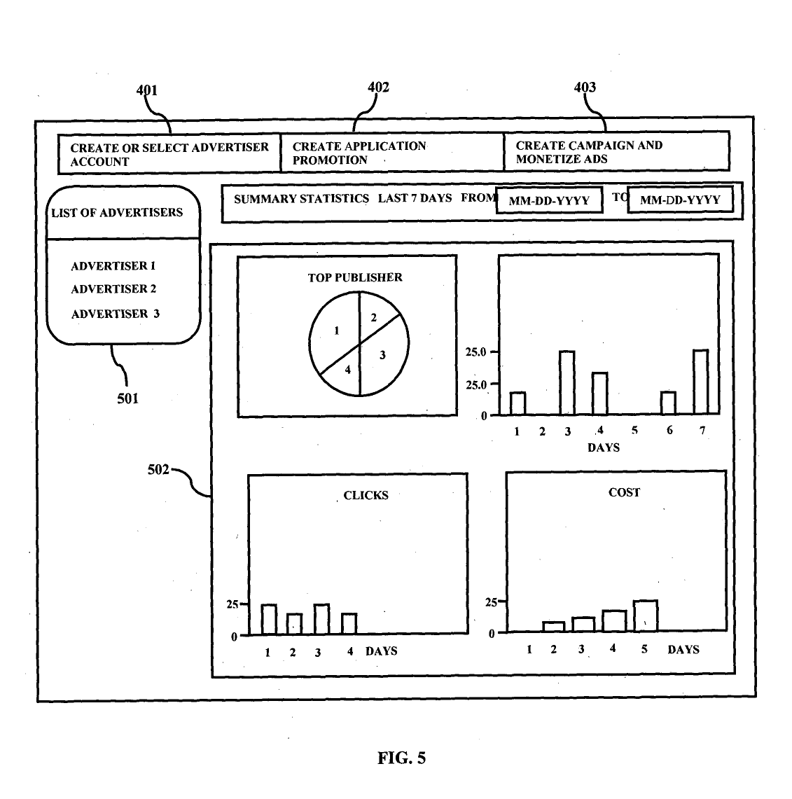

FIG. 5 is a schematic diagram illustrating a user interface of a performance tracking module, according to an embodiment of the present disclosure. The user interface includes a list of advertisers 501 and a tool 502 to display statistics. The tool 502 to display statistics displays one or more of a data on performance of the promotion through one or more representations such as graphs, pie-charts, and/or any other visual graphics. The performance of the promotion can be viewed for any period of time. The performance tracking module provides performance related information from the plurality of distribution channels for a promotional campaign.

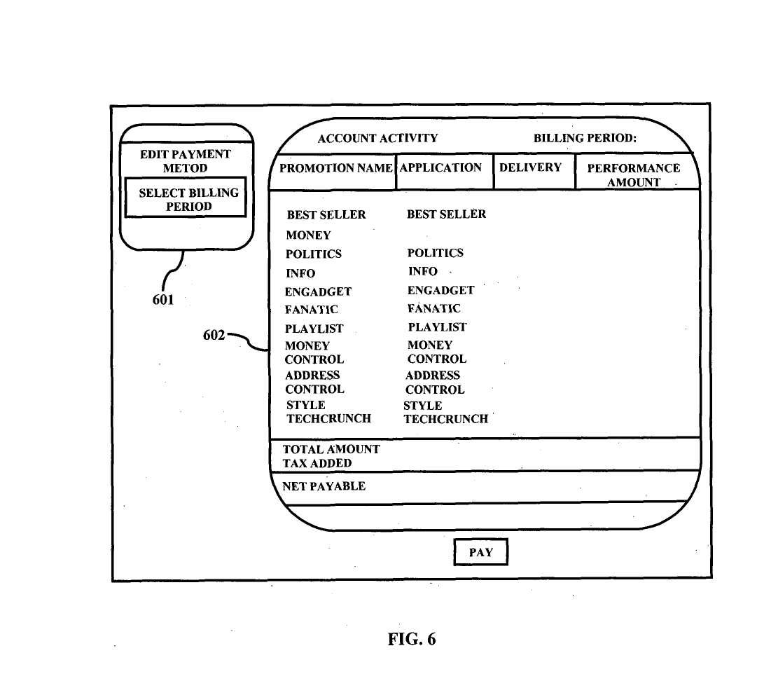

FIG. 6 is a schematic diagram illustrating a user interface of a billing module, according to an embodiment of the present disclosure. The user interface of the billing module includes a payment tool 601 and an account activity tool 602. The payment tool 601 enables the promotion builder to select from a set of available payment options. The account activity tool 602 displays information about the promotion, a billing period, a total amount payable, a tax payable and a pay button. The information about the promotion includes a name of the promotion, a name of the promotional campaign, a delivery status and a balance outstanding.

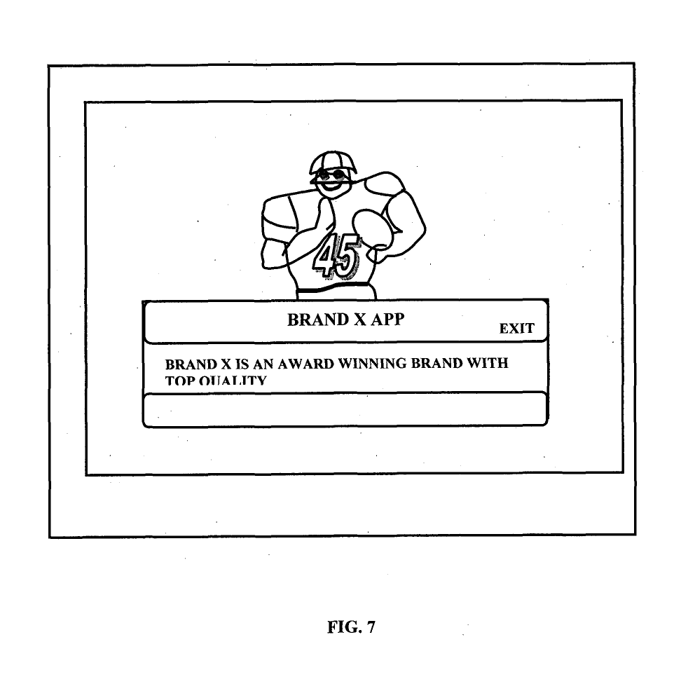

FIG. 7 is an exemplary illustration of execution of a promotion media plan on a television platform, according to an embodiment of the present disclosure. The promotion media artifact for Brand X is promoted as per the information entered in the promotion builder module. The promotion media artefact is published during one or more television slots selected using the scheduler module as shown in FIG. 3. The promotion media artefact is a promotional campaign such as a contest or a poll, for which a viewer selects an option using a set-top box remote or a TV remote control. The viewer actions are tracked and statistical analyses are generated by the performance tracking module.

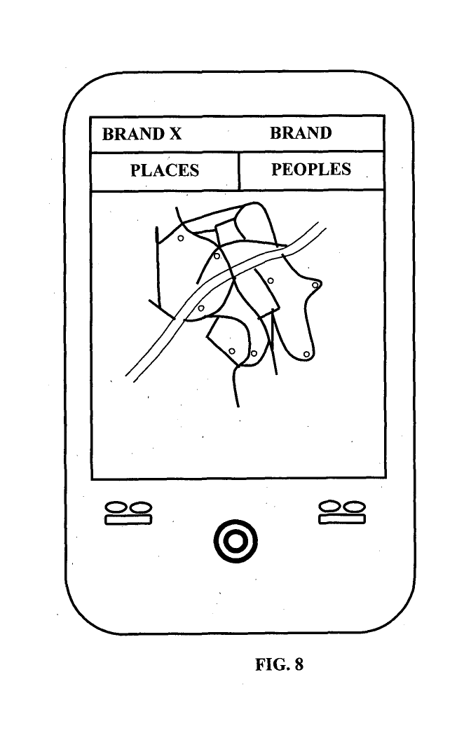

FIG. 8 is an exemplary illustration of execution of a promotion media plan on a mobile device platform, according to an embodiment of the present disclosure. The promotion media artefact can be any promotional campaign. In an example embodiment, the promotion media artefact is a promotional campaign which rates a quality of the roads travelled by a user using an accelerometer on the user's mobile device when placed on dashboard of a vehicle. The promotional campaign displays a name and a logo of a Brand X and thereby acts as a promotion and branding tool for Brand X.

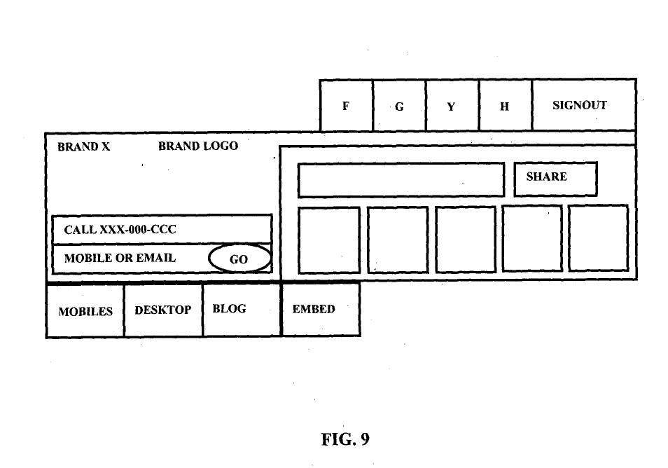

FIG. 9 is an exemplary illustration of execution of an online campaign, according to an embodiment of the present disclosure. The promotion media artefact is a promotional campaign in the form of an interactive banner. The promotion media artefact allows sharing messages with friends on a variety of social networks such as twitter, yahoo, etc through a share button. Through download button, the promotion media artefact can be downloaded on mobile devices and desktops and embedded onto one or more blogs or internet portals.

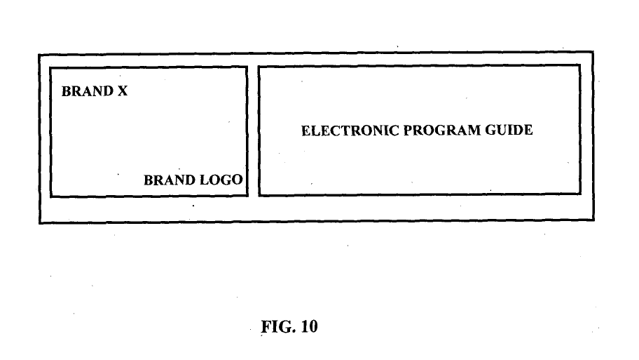

FIG. 10 is an exemplary illustration of execution of a promotion media plan on a hybrid media device platform, according to an embodiment of the present disclosure. The promotion media artefact displays a name and a logo of Brand X on a electronic program guide on a smart TV. In one embodiment, the promotional campaign is a team popularity measurement application where one more teams are listed and are supported by a user of a social network by pressing support buttons. The teams may be sorted in terms of popularity which is measured by the number of supports (e.g., likes) attained by them.

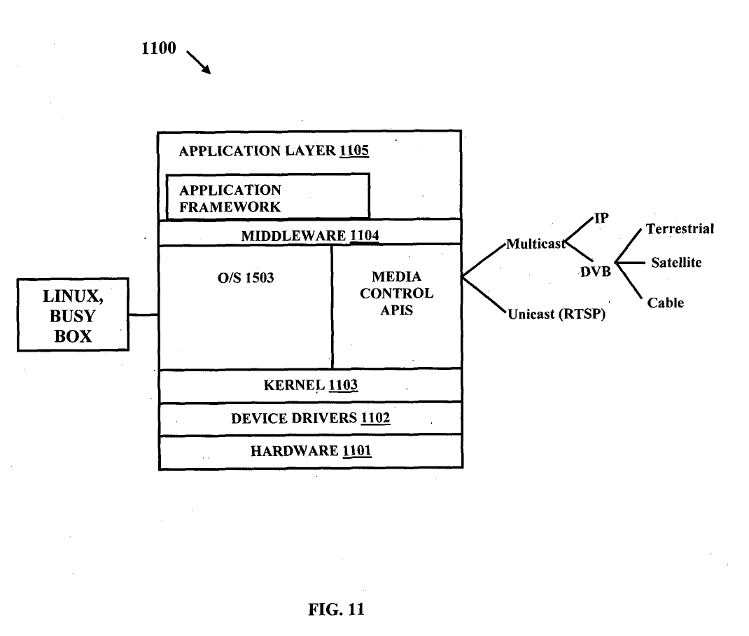

FIG. 11 is an exploded view illustrating a typical set top box layer model with an application container, according to an embodiment of the present disclosure. The set top box layer model 1100 includes a hardware layer 1101, device drivers 1102, an operating system layer 1103, a middleware layer 1104 and an application layer 1105. The application container runs on the application layer 1105 that uses middleware API's to interact with the hardware layer 1101, device drivers 1102 and operating system layer 1103 as shown in FIG. 11.

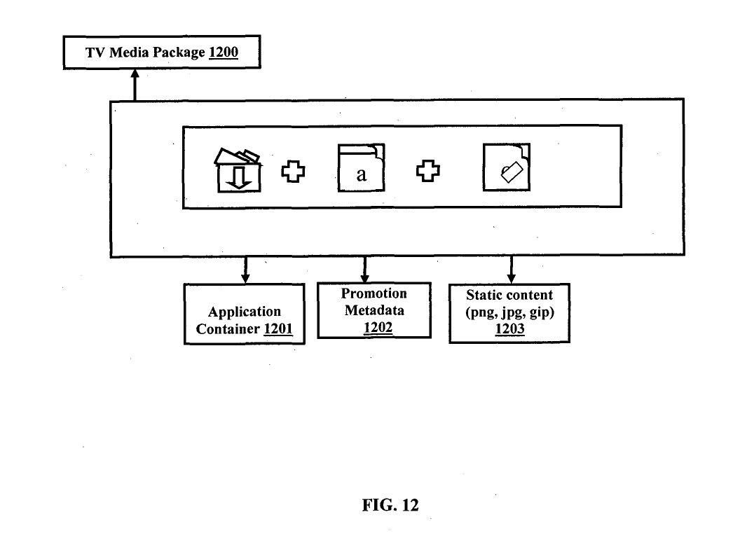

FIG. 12 illustrates a media package for a television, according to an embodiment of the present disclosure. The television data package 1200 includes an application container 1201, a promotion metadata 1202 and a static content 1203. The application container 1201 is a framework that processes the promotion metadata and renders a promotional campaign based on the promotion metadata 1202. The promotion metadata 1202 includes information related to scheduling and rendering content. The static content 1203 include required image files or interactive content.

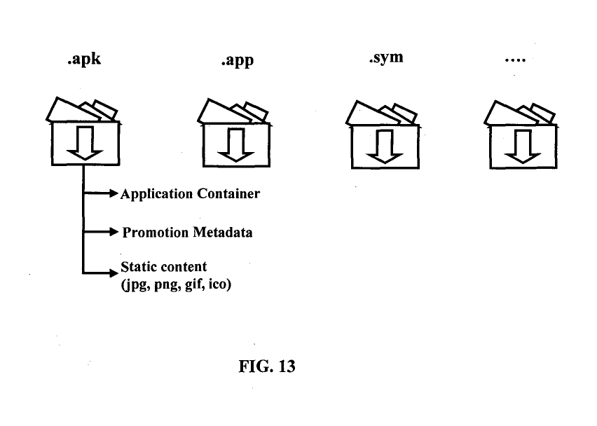

FIG. 13 illustrates a media package for a mobile communication device, according to an embodiment of the present disclosure. Each of the media packages, for example, an .apk file, an .app file, and/or a .sym file, as shown in FIG. 13 include an application container, promotion meta data and content associated with the promotion. The application container renders the promotional campaign based on the promotion metadata.

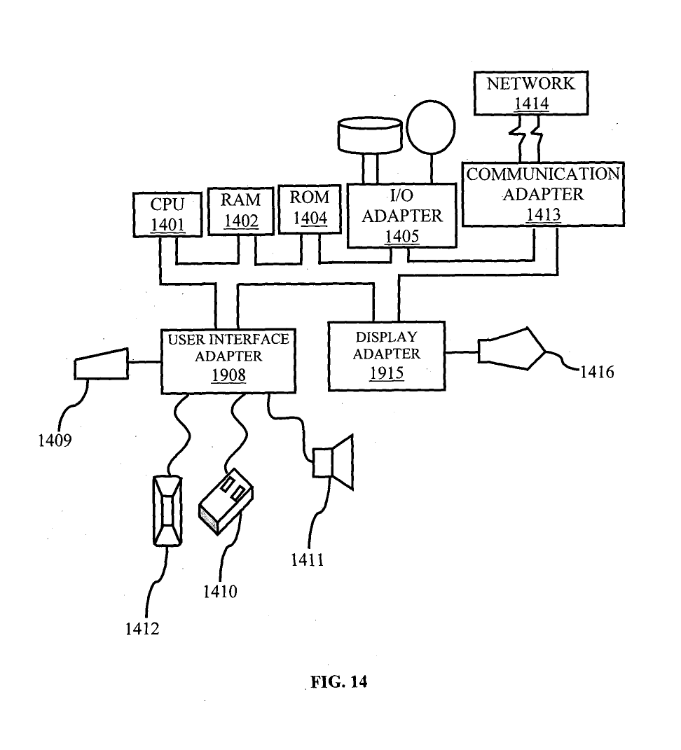

FIG. 14 is a schematic diagram illustrating a computer architecture used in accordance with the embodiment of the present disclosure. The schematic drawing illustrates a hardware configuration of an information handling/computer system in accordance with the embodiments of the present disclosure. The system comprises at least one processor or central processing unit (CPU) 1401. The CPUs 1401 are interconnected via system bus 1402 to various devices such as a random access memory (RAM) 1403, read-only memory (ROM) 1404, and an input/output (I/O) adapter 1405. The I/O adapter 1405 can connect to peripheral devices, such as disk units 1409 and tape drives 1407 or other program storage devices that are readable by the system. The system can read the inventive instructions on the program storage devices and follow these instructions to execute the methodology of the embodiments of the present disclosure.

The system further includes a user interface adapter 1408 that connects a keyboard 1409, mouse 1410, speaker 1411, microphone 1412, and/or other user interface devices such as a touch screen device (not shown) or a remote control to the bus 1402 to gather user input. Additionally, a communication adapter 1413 connects the bus 1402 to a data processing network 1414, and a display adapter 1415 connects the bus 1402 to a display device 1416 which may be embodied as an output device such as a monitor, printer, or transmitter etc.

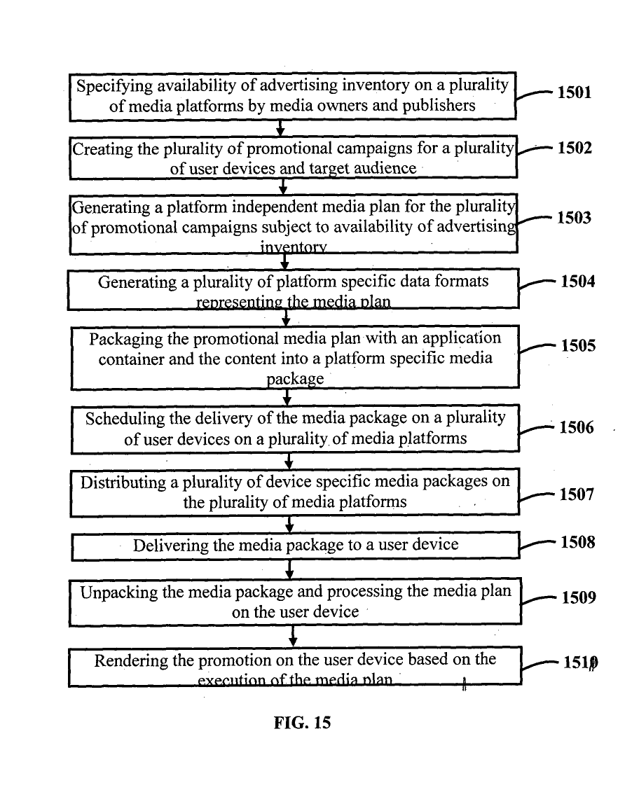

FIG. 15 is a flowchart illustrating a method for creating, distributing and executing a promotional media plan across a plurality of user device platforms, according to an embodiment of the present disclosure. The method comprises steps of specifying availability of advertising inventory on a plurality of media platforms by media owners and publishers 1501, creating the plurality of promotional campaigns for a plurality of user devices and target audience 1502, generating a platform independent media plan for the plurality of promotional campaigns subject to availability of publishing inventory 1503, generating a plurality of platform specific data formats representing the media plan 1504, packaging the promotional media plan with an application container and the content into a platform specific media package 1505, scheduling the delivery of the media package on a plurality of user devices on a plurality of media platforms 1506, distributing a plurality of device specific media packages on the plurality of media platforms 1507, delivering the media package to a user device 1508, unpacking the media package and processing the media plan on the user device 1509 and rendering the promotion on the user device based on the execution of the media plan 1510.

The embodiments of the present disclosure provide a system for creating, distributing and executing a promotional media plan across a plurality of user device platforms. The media plan created is platform independent. The embodiments herein further provide an easy way to render a promotional campaign on a plurality of user device platforms based on the execution of a media plan. The embodiments herein further provide a way to reduce effort and cost involved in developing different media plans for different user device platforms.

The embodiments herein provide an efficient way for an advertisers and agencies to manage a plurality of promotional campaigns running on a plurality of user devices and media platforms.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the appended claims.

What is claimed is:

1. A system for creating and distributing a promotional media plan across a plurality of user device platforms, the system comprising:
a publisher inventory module for providing a inventory of where promotions run;
a promotion builder module to create a common media plan for multiple user device platforms,
a campaign management server to enable multiple media agencies and multiple advertisers to create promotional media plans;
a plurality of distribution channels for distribution of a promotional media plan to a plurality of user devices;
a communication network to facilitate the campaign management server to communicate with the plurality of distribution channels; and
a media package comprising of an application container packaged with the promotion media artifact and promotion media plan for delivering a plurality of promotions to the plurality of distribution channels and user devices;
wherein the promotional media plans are created subject to an availability of the advertising inventory.

2. The system of claim 1, wherein the promotion media artifact includes a static content, a plurality of platform specific data formats corresponding to interactive content associated with the promotional media campaign.

3. The system of claim 1, wherein the promotional media plan is devised for a promotional media artifact comprising at least one of an image, wallpaper, an audio clip, a caller tune, a video clip, an interactive software application, a game, a contest, an advertisement or a content promotion.

4. The system of claim 1, wherein the plurality of distribution channels include at least one of a mobile network, a mobile operator application store, a mobile push notification channel, a handset application store, a connected television, an internet portal, a broadcast television channel, a social network and a hybrid media device.

5. The system of claim 1, wherein the media plan is delivered to the plurality of user device platforms based on a pre-defined schedule or based on a request from a user device, wherein the common media plan includes a promotion metadata compatible with multiple user device platforms.

6. The system of claim 1, wherein the user device is at least one of a television, a mobile communication device or a hybrid media device.

7. The system of claim 1, wherein the plurality of user device platforms comprises:
a plurality of television platforms with each of the television platforms having a different middleware, operating systems and hardware components;
a plurality of mobile communication device platforms with each of the mobile communication device platforms having a different mobile operating system and middleware; and
a plurality of hybrid media device platforms with each of the hybrid media device platforms having a different operating system, middleware and hardware components.

8. The system of claim 1, wherein the publisher inventory specified by the publisher inventory module is an available supply of traffic or impressions that a publisher sells to multiple advertisers interested in targeting an audience group, where the publisher inventory includes at least one of a plurality of channel distribution policies, a distribution frequency, a location to deliver the promotion, a type of user's device, size of the display, duration of the display and position of the display on at least one of a TV, mobile communication device and hybrid device.

9. The system of claim 1, wherein the promotion builder module comprises:
an audience targeting module to enable promotion of the promotional media artifact to a targeted audience based on at least one of demographics, language, location and viewing history; and
a scheduler module for scheduling a delivery of a promotional media plan to a plurality of user devices.

10. The system of claim 1, wherein further comprising:
a provisioning module to deliver the promotion media plan to the plurality of user device platforms through the plurality of distribution channels;
a billing module to process an amount payable for the performance of the promotional media plan; and
a performance tracking module to track and generate a representation of a comparison of performance of the promotion media plan on each of the plurality of user devices.

11. The system of claim 10, wherein the performance tracking module is further adapted for:
tracking and comparing the performance of multiple publishers, the plurality of distribution channels, the plurality of user device platforms, a plurality of service providers and the promotional media plans;
tracking a performance of the promotion media artifact on multiple user device platforms for the plurality of service providers; and
organizing and displaying a performance data for the promotional media plan according to a client's requirement.

12. The system of claim 1, further comprising a distribution module is adapted for:
packaging the promotional media artifact and associated content specific to a user device platform;
packaging the promotion metadata based on a common promotional media plan; and
packaging a application container into a media package,
wherein the promotion metadata includes at least one of a media plan and a information related to availability of inventory and scheduling the display of the promotion media artifact specific to the user device platform.

13. The system of claim 12, wherein the promotion metadata for the television includes a service identification number, a service name, a service type, a display time, a display date, a location of the device, a type of television display, a type of television display format and a frequency of the display.

14. The system of claim 12, wherein the promotion metadata for the mobile communication device includes a user device information, device software, a display date, a display time, a frequency of display and a location of the device.

15. The system of claim 12, wherein the promotion metadata for the hybrid media device includes a service identification number, a service name, a service type, a display time range, a display date, a location of the hybrid media device, a display format and a user's profile information.

16. A method for creating, distributing and executing a promotional media plan across a plurality of user device platforms, the method comprises:
specifying advertising inventory for a plurality of media platforms, creating promotional campaigns and media plans thereof subject to availability of inventory, wherein the promotion media artifact associated with a promotional campaign is any of an image, wallpaper, an audio clip, a caller tune, a video clip, an interactive software application, a game, a contest, an advertisement or a content promotion;
scheduling a delivery of the promotional media plan for each of the promotional campaign;
generating a plurality of platform specific data formats representing the media plan for the plurality of promotional campaigns;
packaging the promotional media plan with an application container corresponding to a user device platform, the plurality of platform specific data formats, and the content into a platform specific media package;
distributing a plurality of device specific media packages to the plurality of user device platforms through a plurality of distribution channels;
delivering the plurality of device specific media packages to a user device based on at least one of demographics, language, location and viewing history; and
processing the plurality of device specific media packages on the user device platform before rendering the promotional media campaign.

17. The method of claim 16, wherein the promotion media artifact is any of an image, wallpaper, an audio clip, a caller tune, a video clip, an interactive software application, a game, a contest, an advertisement or a content promotion.

18. The method of claim 16, wherein processing the plurality of device specific media packages on the user device platform comprising steps of:
requesting media plan details which includes at least one of a plurality of channel distribution policies, a display frequency, a user's location, a type of user's device, size of the display, duration of the display and position of the display on at least one of a TV, mobile communication device and hybrid device;
executing the promotional media plan by comparing promotion meta data such as location, service, time and date ranges for the promotion with the actual state of the user device; and
rendering the content contained in the promotional media artifact associated with a promotional campaign on the user device if the promotion meta data matches the actual state of the user device.

19. The method of claim 16, wherein delivering the device specific media packages to the plurality of distribution channels includes at least one of a push activity in case of a television and a pull activity in case of the mobile and hybrid media device.

20. The method of claim 19, wherein delivering the device specific media packages to a television platform comprises:
encoding the media package;
streaming the media package using a broadcasting system;
acquiring the media package on a set top box; and
decoding the media package on the set top box;
wherein the media package for television is specific to the broadcasting system platform and the set top box platform.

21. The method of claim 19, wherein delivering the device specific media packages to the mobile communication device comprises:
packaging the promotional metadata, the static content and the application container; and
push or pull the media package on to the mobile communication device.

22. The method of claim 19, wherein delivering the device specific media packages to the hybrid media device comprises:
packaging the promotional metadata, the static content and the application container; and
push or pull the media package on to the hybrid media device.

23. The method of claim 16, wherein the method further comprises:
provisioning a usage of the promotional media artifact on the plurality of user devices based on the promotional media plan;
receiving a reporting information from the plurality of user devices;
tracking and collecting a performance data from the plurality of user device platforms;
obtaining a billing data based on the performance;
organizing and displaying a billing and payment options according to the client's requirements; and
organizing and displaying the performance data according to the client's requirements.
